(19) United States
(12) Patent Application Publication
(10) Pub. No.: US 2012/0050152 A1
(43) Pub. Date: Mar. 1, 2012

(54) METHOD, APPARATUS AND COMPUTER PROGRAM PRODUCT FOR ADAPTIVE PRESENTATION OF INFORMATION ON A DISPLAY

(75) Inventors: Ilkka Tapani Salminen, Tampere (FI); Mikko Antero Nurmi, Tampere (FI)

(73) Assignee: Nokia Corporation, Espoo (FI)

(21) Appl. No.: 12/871,686

(22) Filed: Aug. 30, 2010

(51) Int. Cl. G09G 5/10; G09G 5/00

(52) U.S. Cl. 345/156; 345/690

(57) ABSTRACT

Provided herein are a method, apparatus and computer program product for operating a display including providing for operation of a display in a first mode, providing for operation of the display in a second mode, and transitioning from operating the display in the first mode to operating the display in the second mode in response to an amount of time elapsing without detecting a user input. The amount of time may be variable in response to at least one of: the information presented on the display in the first mode; the application presenting the information on the display in the first mode, a sensor input of a device comprising the display; or whether or not a user input is detected within a predetermined response time after transitioning from operating the display in the first mode to operating the display in the second mode.

### TECHNOLOGICAL FIELD

Example embodiments of the present invention relate generally to the presentation of information on a display, and more particularly, to a method of presenting information on a display that is based upon the type of information displayed and learned behaviors of a viewer of the display.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices are becoming small, portable computing devices that are capable of running a variety of applications, some of which benefit from a larger display. The displays of mobile devices have become increasingly large such that they may now usurp surface space that may have previously been used for a traditional tactile keypad such that some mobile devices may flip open to present a keypad or the display may also serve as a touch-screen user interface. One negative aspect of large displays is the power consumption requirement to present the vast amounts of information available through mobile devices. As mobile devices are intended to be portable, a smaller size is generally preferable which may limit the size of battery that can be used with the mobile device. A display such as a liquid crystal display (LCD), a light emitting diode (LED) display, or an organic light emitting diode (OLED) display may consume the battery power of a mobile device relatively quickly if the display remains on for long periods. As such, many devices use a “sleep” mode that turns off the display or mode that dims or reduces the brightness of a display in an effort to conserve battery power when it is believed that a user is no longer viewing the display.

### SUMMARY

In general, an example embodiment of the present invention provides an improved method of transitioning from a first display mode, where the display may be of a first brightness, to a second display mode, where the display may be of a second brightness that is less than the first brightness.

In particular, the method of example embodiments includes providing for operation of a display in a first mode, providing for operation of the display in a second mode, and transitioning from operating the display in the first mode to operating the display in the second mode in response to an amount of time elapsing without detecting a user input. The amount of time may be variable in response to at least one of: the information presented on the display in the first mode; the application presenting the information on the display in the first mode, a sensor input of a device comprising the display; or whether or not a user input is detected within a predetermined response time after transitioning from operating the display in the first mode to operating the display in the second mode. The first mode may include a first level of brightness and the second mode may include a second level of brightness that is less than the first level. The amount of time may be variable in response to at least two of the information presented on the display in the first mode; the application presenting the information on the display in the first mode, a sensor input of a device comprising the display; and whether or not a user input is detected within a predetermined response time after transitioning from operating the display in the first mode to operating the display in the second mode. The amount of time may be variable in response to whether or not a user input is detected within a predetermined response time after transitioning from operating the display in the first mode to operating the display in the second mode, wherein the amount of time is increased in response to detecting a user input within a predetermined response time after transitioning from operating the display in the first mode to operating the display in the second mode. The increased amount of time may be learned and stored for future use. The amount of time may be decreased in response to not detecting a user input within a predetermined response time after transitioning from operating in the display in the first mode to operating the display in the second mode. The decreased amount of time may be learned and stored for future use. The amount of time may be variable in response to the information presented on the display in the first mode, where the amount of time is relatively greater in response to the information presented on the display in the first mode being measured at a first difficulty level and relatively lower in response to the information presented on the display in the first mode being measured at a second difficulty level which is lower than the first difficulty level. The amount of time may be variable in response to a sensor input of a device including the display, where the sensor input includes the detection of motion of the device.

According to another embodiment of the present invention, an apparatus is provided. The apparatus may include at least one processor and at least one memory including computer program code. The at least one memory and the computer program code may be configured to, with the at least one processor, cause the apparatus to provide for operation of a display in a first mode, provide for operation of the display in a second mode, and transition from operating the display in the first mode to operating the display in the second mode in response to an amount of time elapsing without detection of a user input. The amount of time may be variable in response to at least one of: the information presented on the display in the first mode; the application presenting the information on the display in the first mode, a sensor input of a device comprising the display; or whether or not a user input is detected within a predetermined response time after transitioning from operating the display in the first mode to operating the display in the second mode. The first mode may include a first level of brightness and the second mode may include a second level of brightness that is less than the first level. The amount of time may be variable in response to at least two of the information presented on the display in the first mode; the application presenting the information on the display in the first mode, a sensor input of a device comprising the display; and whether or not a user input is detected within a predetermined response time after transitioning from operating the display in the first mode to operating the display in the second mode. The amount of time may be variable in response to whether or not a user input is detected within a predetermined response time after transitioning from operating the display in the first mode to operating the display in the second mode, wherein the amount of time is increased in response to detecting a user input within a predetermined response time after transitioning from operating the display in the first mode to operating the display in the second mode. The increased amount of time may be learned and stored for future use. The amount of time may be decreased in response to not detecting a user input within a predetermined response time after transitioning from operating the display in the first mode to operating the display in the second mode. The decreased amount of time may be learned and stored for future use. The amount of time may be variable in response to the information presented on the display in the first mode, where the amount of time is relatively greater in response to the information presented on the display in the first mode being measured at a first difficulty level and relatively lower in response to the information presented on the display in the first mode being measured at a second difficulty level which is lower than the first difficulty level. The amount of time may be variable in response to a sensor input of a device including the display, where the sensor input includes the detection of motion of the device.

A further embodiment of the invention may include a computer program product including at least one computer-readable storage medium having computer-executable program code instructions stored therein. The computer executable program code instructions may include program code instructions for providing for operation of a display in a first mode, program code instructions for providing for operation of the display in a second mode, and program code instructions for transitioning from operating the display in the first mode to operating the display in the second mode in response to an amount of time elapsing without detecting a user input. The amount of time may be variable in response to at least one of: the information presented on the display in the first mode; the application presenting the information on the display in the first mode, a sensor input of a device comprising the display; or whether or not a user input is detected within a predetermined response time after transitioning from operating the display in the first mode to operating the display in the second mode. The first mode may include a first level of brightness and the second mode may include a second level of brightness that is less than the first level. The amount of time may be variable in response to at least two of the information presented on the display in the first mode; the application presenting the information on the display in the first mode, a sensor input of a device comprising the display; and whether or not a user input is detected within a predetermined response time after transitioning from operating the display in the first mode to operating the display in the second mode. The amount of time may be variable in response to whether or not a user input is detected within a predetermined response time after transitioning from operating the display in the first mode to operating the display in the second mode, wherein the amount of time is increased in response to detecting a user input within a predetermined response time after transitioning from operating the display in the first mode to operating the display in the second mode. The increased amount of time may be learned and stored for future use. The amount of time may be decreased in response to not detecting a user input within a predetermined response time after transitioning from operating in the display in the first mode to operating the display in the second mode. The decreased amount of time may be learned and stored for future use. The amount of time may be variable in response to the information presented on the display in the first mode, where the amount of time is relatively greater in response to the information presented on the display in the first mode being measured at a first difficulty level and relatively lower in response to the information presented on the display in the first mode being measured at a second difficulty level which is lower than the first difficulty level. The amount of time may be variable in response to a sensor input of a device including the display, where the sensor input includes the detection of motion of the device.

### BRIEF DESCRIPTION OF THE DRAWING(S)

Having thus described certain example embodiments of the invention in general terms, reference will now be made to the accompanying drawings, which are not necessarily drawn to scale, and wherein:

FIG. 1 illustrates an communication system in accordance with an example embodiment of the present invention;

FIG. 2 is a schematic block diagram of a mobile device according to an example embodiment of the present invention;

FIG. 3 is an illustration of a display presenting different levels of information according to example embodiments of the present invention.

FIG. 4 is a flow chart of a method of operating a display according to an example embodiment of the present invention; and

FIG. 5 is a flow chart of a method of operating a display according to another example embodiment of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

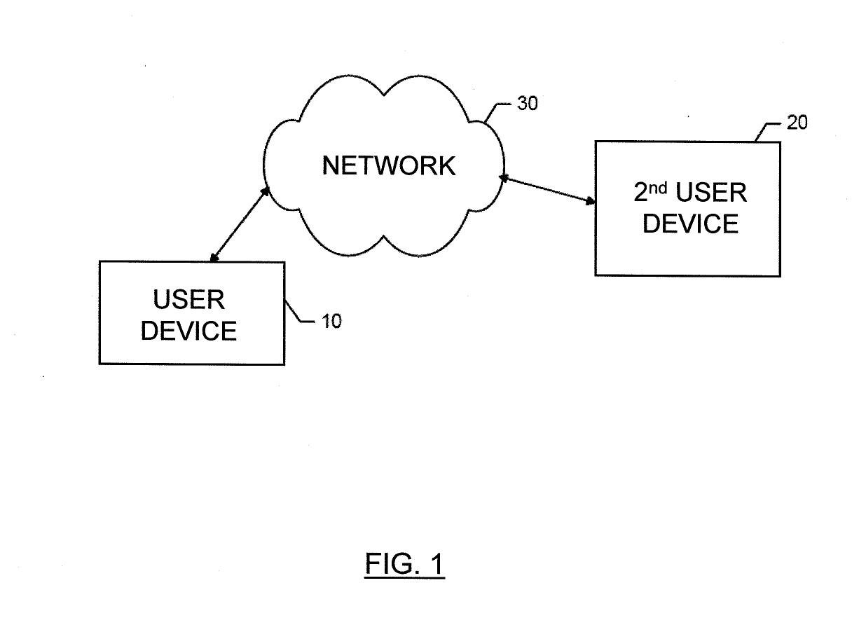

A session may be supported by a network 30 as shown in FIG. 1 that may include a collection of various different nodes, devices or functions that may be in communication with each other via corresponding wired and/or wireless interfaces or in ad-hoc networks such as those functioning over Bluetooth® interfaces. As such, FIG. 1 should be understood to be an example of a broad view of certain elements of a system that may incorporate example embodiments of the present invention and not an all inclusive or detailed view of the system or the network 30. Although not necessary, in some example embodiments, the network 30 may be capable of supporting communication in accordance with any one or more of a number of first-generation (1G), second-generation (2.G), 2.5G, third-generation (3G), 3.5G, 3.9G, fourth-generation (4G) mobile communication protocols and/or the like.

One or more communication terminals, such as the mobile terminal 10 and the second mobile terminal 20, may be in communication with each other via the network 30 and each may include an antenna or antennas for transmitting signals to and for receiving signals from a base site, which could be, for example a base station that is part of one or more cellular or mobile networks or an access point that may be coupled to a data network, such as a local area network (LAN), a metropolitan area network (MAN), and/or a wide area network (WAN), such as the Internet. In turn, other devices (e.g., personal computers, server computers or the like) may be coupled to the mobile terminal 10 and the second mobile terminal 20 via the network 30. By directly or indirectly connecting the mobile terminal 10 and the second mobile terminal 20 and other devices to the network 30, the mobile terminal 10 and the second mobile terminal 20 may be enabled to communicate with the other devices or each other, for example, according to numerous communication protocols including Hypertext Transfer Protocol (HTTP) and/or the like, to thereby carry out various communication or other functions of the mobile terminal 10 and the second mobile terminal 20, respectively.

In example embodiments, either of the mobile terminals may be mobile or fixed communication devices. Thus, for example, the mobile terminal 10 and the second mobile terminal 20 could be, or be substituted by, any of personal computers (PCs), personal digital assistants (PDAs), wireless telephones, desktop computer, laptop computer, mobile computers, cameras, video recorders, audio/video players, positioning devices, game devices, television devices, radio devices, or various other devices or combinations thereof.

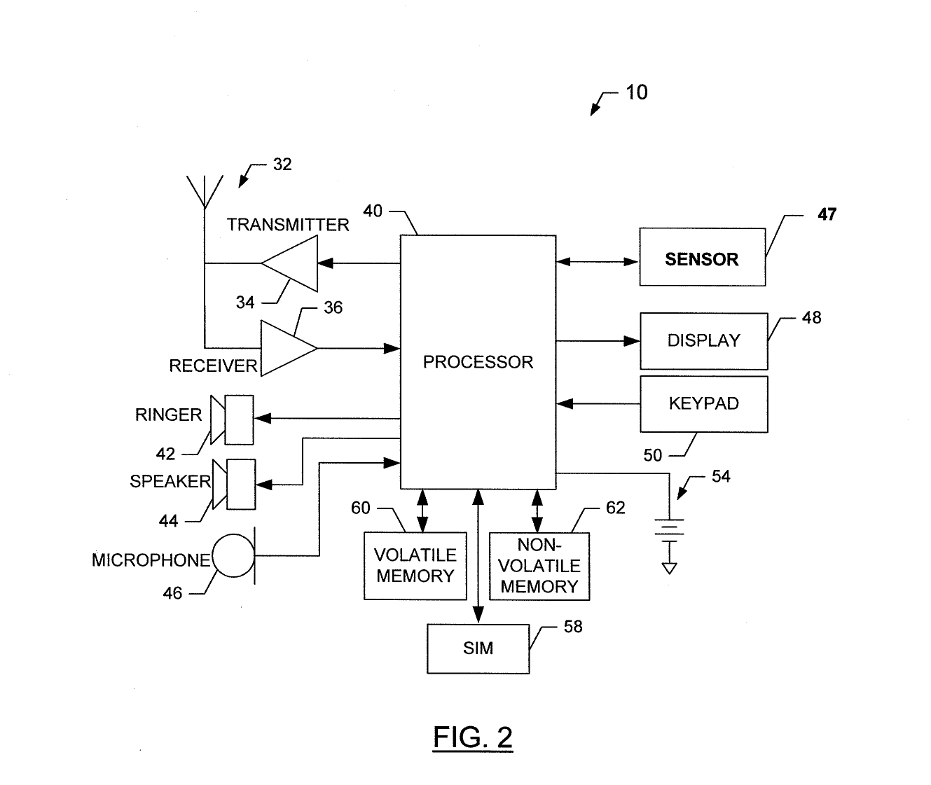

Although the mobile terminal 10 may be configured in various manners, one example of a mobile terminal that could benefit from an example embodiment of the invention is depicted in the block diagram of FIG. 2. While several embodiments of the mobile terminal may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radios, global positioning system (GPS) devices, or any combination of the aforementioned, and other types of communication devices, may employ an example embodiment of the present invention. As described, the mobile terminal may include various means for performing one or more functions in accordance with an example embodiment of the present invention, including those more particularly shown and described herein. It should be understood, however, that a mobile terminal may include alternative means for performing one or more like functions, without departing from the spirit and scope of the present invention.

The mobile terminal 10 illustrated in FIG. 2 may include an antenna 32 (or multiple antennas) in operable communication with a transmitter 34 and a receiver 36. The mobile terminal may further include an apparatus, such as a processor 40, that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile terminal may be capable of operating with one or more air interface standards, communication protocols, modulation types, and access types. By way of illustration, the mobile terminal may be capable of operating in accordance with any of a number of first, second, third and/or fourth-generation communication protocols or the like. For example, the mobile terminal may be capable of operating in accordance with second-generation (2G) wireless communication protocols IS-136, GSM (Global System for Mobile communications) and IS-95, or with third-generation (3G) wireless communication protocols, such as UMTS (Universal Mobile Telecommunications System), CDMA2000 (Code Division Multiple Access), wideband CDMA (WCDMA) and time division-synchronous CDMA (TD-SCDMA), with 3.9G wireless communication protocols such as E-UTRAN (evolved-UMTS (Universal Mobile Telecommunications System) terrestrial radio access network), with fourth-generation (4G) wireless communication protocols or the like.

It is understood that the apparatus, such as the processor 40, may include circuitry implementing, among others, audio and logic functions of the mobile terminal 10. The processor 40 may be embodied in a number of different ways. For example, the processor 40 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 40 may include one or more processing cores configured to perform independently. A multi-core processor may enable multiprocessing within a single physical package. Additionally or alternatively, the processor 40 may include one or more processors configured in tandem via the bus to enable independent execution of instructions, pipelining and/or multithreading.

In an example embodiment, the processor 40 may be configured to execute instructions stored in the memory device 62 or otherwise accessible to the processor 40. Alternatively or additionally, the processor 40 may be configured to execute hard coded functionality. As such, whether configured by hardware or software methods, or by a combination thereof, the processor 40 may represent an entity (e.g., physically embodied in circuitry) capable of performing operations according to embodiments of the present invention while configured accordingly. Thus, for example, when the processor 40 is embodied as an ASIC, FPGA or the like, the processor 40 may be specifically configured hardware for conducting the operations described herein. Alternatively, as another example, when the processor 40 is embodied as an executor of software instructions, the instructions may specifically configure the processor 40 to perform the algorithms and/or operations described herein when the instructions are executed. However, in some cases, the processor 40 may be a processor of a specific device (e.g., a mobile terminal or network device) adapted for employing embodiments of the present invention by further configuration of the processor 40 by instructions for performing the algorithms and/or operations described herein. The processor 40 may include, among other things, a clock, an arithmetic logic unit (ALU) and logic gates configured to support operation of the processor 40.

The mobile terminal 10 may also comprise a user interface including an output device such as an earphone or speaker 44, a ringer 42, a microphone 46, a display 48, and a user input interface, which may be coupled to the processor 40. The mobile terminal 10 may further include sensor(s) 47 for detecting a stimulus such as a button for detecting a depression, a touch sensitive display for detecting a touch, or a motion sensor to detect motion, The user input interface, which allows the mobile terminal to receive data, may include any of a number of devices allowing the mobile terminal to receive data, such as a keypad 50, a touch sensitive display (not shown) or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the mobile terminal may include an interface device such as a joystick or other user input interface. The mobile terminal may further include a battery 54, such as a vibrating battery pack, for powering various circuits that are used to operate the mobile terminal, as well as optionally providing mechanical vibration as a detectable output.

The mobile terminal 10 may further include a user identity module (UIM) 58, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile terminal may be equipped with memory. For example, the mobile terminal may include volatile memory 60, such as volatile Random Access Memory (RAM) including a cache area for the temporary storage of data. The mobile terminal may also include other non-volatile memory 62, which may be embedded and/or may be removable. The non-volatile memory may additionally or alternatively comprise an electrically erasable programmable read only memory (EEPROM), flash memory or the like. The memories may store any of a number of pieces of information, and data, used by the mobile terminal to implement the functions of the mobile terminal. For example, the memories may include an identifier, such as an international mobile equipment identification (IMEI) code, capable of uniquely identifying the mobile terminal. Furthermore, the memories may store instructions for determining cell id information. Specifically, the memories may store an application program for execution by the processor 40, which determines an identity of the current cell, e.g., cell id identity or cell id information, with which the mobile terminal is in communication.

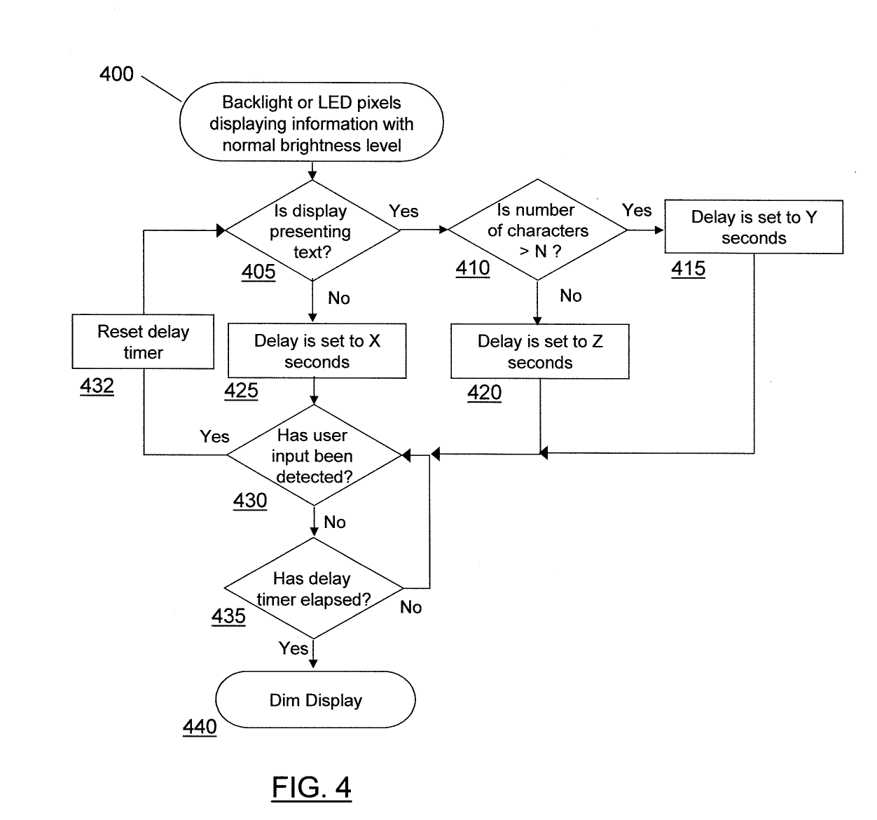

An example embodiment of a communication network in accordance with one example embodiment is presented by FIG. 1. A flowchart illustrating operations performed by or in relation to the network of an example embodiment is presented in the flowchart of FIG. 4. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

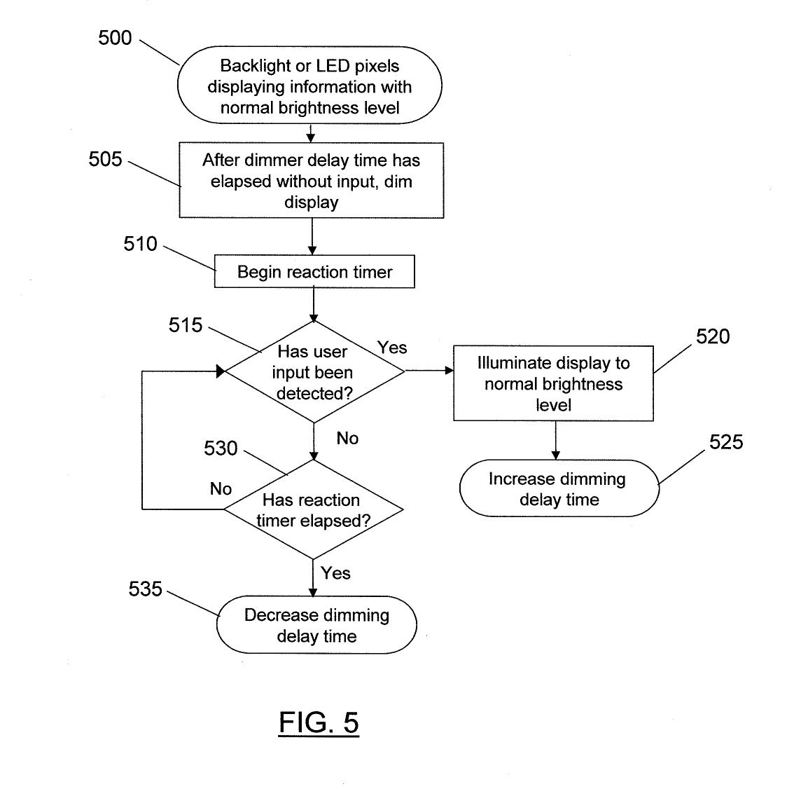

In an example embodiment, an apparatus for performing the methods of FIGS. 4 and 5, described further below, may comprise a processor (e.g., the processor 40) configured to perform some or each of the operations (400-440 or 500-535) described below. The processor may, for example, be configured to perform the operations (400-440 or 500-535) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-440 or 500-535 may comprise, for example, the processor 40 and/or a device or circuit for executing instructions or executing an algorithm for processing information as described further below.

Example embodiments of the present invention may include displays, such as display 48 of FIG. 2, that are illuminated by a backlight (e.g., a Liquid Crystal Diode or LCD display) or possibly by light emitting diode (LED) pixels or organic light emitting diode (OLED) pixels. Such displays may consume a significant amount of power when they are illuminated at their normal brightness as typical when presenting information to a user. As mobile terminals (e.g., mobile terminal 10) implementing such displays are often powered by a battery, it may be desirable to increase the battery life of the mobile terminal by dimming or turning off the display when it is not actively being used. Further, reducing power consumption, regardless of the power source, is generally desirable. The dimming operation is typically performed automatically in response to the mobile terminal operating for a predetermined amount of time without detecting a user input. Upon the predetermined time elapsing without detecting a user input, the display may enter a dimmed mode or a mode where the display is configured to draw less power from the power source. Such dimmed modes or reduced power modes may include wherein a backlight is turned off, the backlight may be dimmed (e.g., by reducing power to a backlight or turning off portions of a multi-element backlight), illuminated pixels may be turned off, or illuminated pixels may be dimmed. Further methods may include reducing the number of illuminated pixels, reducing the overall power to the display, or any such method in which the display is configured to draw less power than when in a normal operating mode. Each of the above modes will be referred to generally herein as “dimmed,” whereby dimming a display results in a dimmed mode or dimmed display mode.

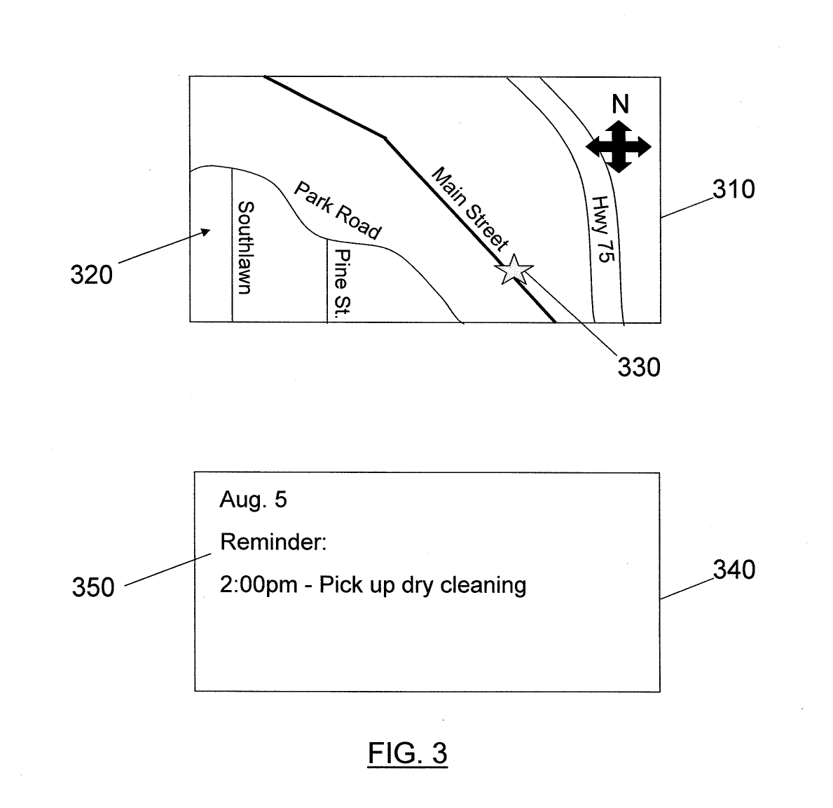

Mobile terminals according to example embodiments of the present invention may include displays that are configured to present large amounts of information to a user. As the capabilities of mobile terminals are ever increasing, the amount of information available to present on the display is also increasing. Such displays may present text, pictures, or other elements that a user may observe and take-in over a period of time. The information presented on the display may take anywhere from a moment for a user to glance at the display to several minutes wherein a user is reading and possibly re-reading text or observing the details of a figure or picture. Further, different applications executed by a mobile terminal may each typically present different kinds of information that require different amounts of time for a user to observe and fully understand. FIG. 3 depicts illustrations of two displays according to example embodiments of the present invention. Display 310 includes a map 320 showing a position marker 330. A user that is observing the map 320 and the mobile terminal position marker 330 may take, for example, fifteen to thirty seconds to fully understand their location on the map, particularly if they aren't familiar with the area that the map illustrates. Conversely, display 340 includes a reminder of an event which a user could fully understand in less than five seconds. As such, the time needed to fully understand the depictions of both displays is substantially different.

Example embodiments of the present invention may be configured to improve and extend battery life over the prior art by more accurately tailoring the power consumption of a display to the usage and habits of a user that views information presented on the display. To increase the battery life of a device through reduction in the power consumption of the display of a mobile device, it is desirable to only illuminate the display while information is being observed on the display. When a display is illuminated and a user is not viewing the display, power is being consumed unnecessarily. While dimming the display of a mobile terminal quickly may extend battery life, the quick dimming may prove to be an annoyance to a user leading to dissatisfaction in the product. As such, it is desirable to create a balance between reduced power consumption and illuminating a display as long as is necessary for a user to understand the information displayed. Mobile terminals typically include a timer that has a user-configurable time delay between the last detected user input and entering a dimmed mode. This user-configurable time delay is often 10, 20, 30, or 60 seconds. However, as noted above, different types of information require different observation times such that a single time delay parameter used before entering a dimmed mode is not always efficient.

Example embodiments of the present invention provide for varying time delay parameters for dimming of a display of a mobile terminal where the varying time delay parameters are determined based upon the active application being presented by the display and learned behaviors of a user of the mobile terminal. The time delay before dimming a display may also be influenced by the operative state of the mobile terminal as will be further described below.

FIG. 4 depicts an example embodiment of the present invention showing a flow chart of operations that may be performed on a device (e.g., mobile terminal 10) where the operations may be performed by a processor (e.g. processor 40). The backlight or LED pixels may display information at a normal brightness level at 400. The processor may determine if the display is presenting text at 405. If the display is presenting text, the processor may determine how many characters are displayed (e.g. larger number of characters likely means more text for a user to read) at 410. If the number of characters exceeds a threshold N, the time delay before dimming the display is set to Y seconds at 415. If the number of characters is below a threshold N at 410, the delay before dimming the display is set to Z seconds at 420. It is noted that such a method may include multiple levels of thresholds with multiple time delays rather than the single threshold depicted. Any number of levels of detail are possible with such a method. Further, the time delay may be directly proportional to the number of characters displayed rather than using a threshold value as depicted. Referring back to 405, if the display is not presenting text the time delay before dimming may be set to X seconds at 425. If the display is not presenting text, the display may be presenting pictures or other elements that may typically require a different time period to review and understand than displayed text may typically take. At 430, the processor may determine if a user input has been detected. If a user input has been detected at 430, the process may begin again at 405 as the user input may change what is presented on the display. If a user input has not been detected at 430, the processor may determine if the delay timer (which was set to X, Y, or Z) has elapsed at 435. If the delay timer has not elapsed, the processor may then again determine if a user input has been detected that would reset the delay timer at 432 before beginning the process again at 405. If the delay timer has elapsed at 435, the display is dimmed at 440. The process described above is an example embodiment of a dimming delay timer that is determined based upon the content presented on a display. This method may be used independently or in conjunction with additional methods for calculating a dimming delay timer as will be discussed further below.

While the example embodiment of FIG. 4 equates a number of characters with an amount of time estimated for a user to understand the information displayed, it is appreciated that the number of characters is only one of a number of possible measures. Other such measures may include a number of objects (e.g., pictures, text boxes, graphs, charts, etc.) or the complexity of the text displayed as determined through a measure such as the Gunning Fog index that measures the readability of English text. As such, a “difficulty level” could be used in place of a number of characters in FIG. 4 to generically assess the amount of time estimated for a user to understand the information displayed based on one or more individual measures of the information displayed. The delay time before dimming the display of a device may then be set based upon the difficulty level as determined through these one or more measures. An additional factor that may influence the difficulty level may include the language that the information is displayed in. If the language is not the native language of the user (e.g., not the same as the language that the phone menus are set to), then the difficulty level may be increased.

Another example embodiment of the present invention is illustrated in the flowchart of FIG. 5 which may be used independently, or in cooperation with the method depicted in the flowchart of FIG. 4. In combination, the method of FIG. 5 may be implemented, such as by processor 40, beginning at 440 of FIG. 4. Information may be presented on the display of a mobile terminal at 500. After a dimmer delay time has elapsed without input at 505, the display is dimmed. Upon dimming at 505, a reaction timer is initiated at 510. The processor may determine if a user input has been detected at 515 before the reaction timer elapses. If a user input has been detected, the display is illuminated to the normal brightness level at 520. In response to the dimmed display being interrupted by a reactive input at 515, the dimming delay time is increased at 525. If the embodiment of FIG. 5 is used in cooperation with the embodiment of FIG. 4, the dimming delay time that may be increased may be the values of X, Y, or Z, whichever dimming delay timer value was active at 430. Referring back to FIG. 5, if no user input was detected at 515, the processor may determine if the reaction timer has elapsed at 530. The reaction timer may be on the order of around 3 seconds, or a value that indicates to the processor that a user of the mobile terminal was viewing the information presented on the display when the display was dimmed. Generally such a reaction will occur in under 5-10 seconds. If the timer has not yet elapsed at 530, the processor may determine again if a user input has been detected at 515. Once the reaction timer has elapsed, the dimming delay time may be decreased at 535.

The increase and decrease of the dimming delay time occurring at 525 and 535 may be in small steps as the process becomes an iterative learning process for the processor to learn the behaviors of a viewer of the information displayed on a device. Optionally, the increase of dimming delay time at 525 might be significantly larger than the decrease at 535 such that a user is interrupted by the dimming of the display less often, while more power is consumed during the iterative learning process. Further, the device may be configured to favor reduced power consumption over user interruption such that the decrease in dimming delay time at 535 is larger than the increase in dimming delay time at 525. Such a configuration would lead to lower power consumption during the iterative learning process, but would interrupt a user more frequently by dimming the display while the information is still being viewed by a user. Additionally, the dimming delay times may be coupled to a user profile such that a mobile terminal implementing embodiments of the present invention may have different dimming delay time parameters for different users. Such user profiles may be desirable when one user of a mobile terminal is a relatively fast reader while another user of the mobile terminal may be relatively slower.

A further example embodiment of the present invention may be used alone or in cooperation with one or both of the aforementioned examples. A dimming delay timer may be based upon the active application that is being presented on the display, or the application that is occupying a larger portion of the display than other applications. For example, a dimming delay timer may be relatively longer for an email program than a dimming delay timer would be for an SMS text message program. Similarly, a dimming delay timer may be relatively short when there is no active program and the display is presenting only the home screen of a mobile terminal. The dimming delay timer may be relatively short when the display is presenting only a clock; however, the delay timer may be slightly longer when an analog clock is presented on the display versus a digital clock. In such an embodiment as applied in cooperation with the embodiment of FIG. 4, the dimmer delay times X, Y, and Z may be one set of times when used with an email program and another set of times when used with a web browser program.

In addition to the active application influencing the dimming delay time, the dimming delay time may be influenced by a familiarity factor. Such a familiarity factor may be useful when a user views a particular application, web page, or other displayed information regularly such that the user may know where to look on the display for the information that the user is interested in without searching all of the information on the display. An example of such an embodiment may include a sports information web page presenting articles and current sports scores. A user who views the web page regularly may know precisely where the scores are that they are interested in such that even though the page may be complex and have a high difficultly level (typically resulting in a longer dimming delay timer), the dimming delay timer may be shortened as the apparatus may have learned that the user only needs to view the page briefly. The learning process may be similar to the iterative learning process outlined above with respect to FIG. 5.

A still further example embodiment of the present invention that may be used alone or in cooperation with one, some, or all of the other embodiments may provide for a dimming timer that is variable based upon the physical state of the mobile terminal or the environment in which the mobile terminal may be operating. For example, if the mobile terminal is of a “flip” style or “sliding” style that includes a keypad that may be hidden, the dimmer delay timer may be longer when the keypad is exposed as the mobile terminal may be assumed to be in use by a user since such devices are not regularly stored with the keypads exposed. Also, if the mobile terminal includes a locating feature such as GPS or node-based location, the dimmer delay timer may be increased when the locating feature determines that the mobile terminal is moving. Such an embodiment may be beneficial to a user that is viewing information presented on a display while moving (e.g., walking, driving a car, cycling, etc.), where the user's focus may not be entirely on the display of the mobile terminal.

Further factors that may influence the dimming delay time may include elements such as the time of day, people nearby (as detected by near-field communications channels or through locating methods), ambient light (e.g., longer dimming delay timer in bright sunlight), user-interface view (e.g., horizontal/vertical viewing), font size of text, etc. Each factor that may influence the dimming delay time may be a set value or may be learned through an iterative process such as that of FIG. 5. For example, a device being operated by a user in bright sunlight may add twenty percent (20%) to the dimming delay timer or the device may learn that a user typically takes 5 seconds longer to view and understand information displayed when the device is in bright sunlight. Further, a device being operated by a user with text in an 8-point font may take a user 10% longer to view than text in a 10-point font. Still further, each of the above factors may contribute to a total factor that influences the dimming delay time such that in the previous two examples, if a device is presenting text to a user in 8-point font in bright sunlight, the dimming delay timer may be increased by 20% for operating in bright sunlight and an additional 10% for presenting the text in 8-point font.

Each of the above embodiments may be used in cooperation such that a mobile terminal implementing example embodiments of the present invention may include an application-based dimmer delay timer embodied, for example, by processor 40 that is dependent upon the active application presented on the display. The dimmer delay timer may further be influenced by the content of the information presented on the display, such as, when the display is presenting a relatively large amount of text. Further, the dimmer delay timer may be influenced by the adaptive learning of the mobile terminal based upon whether or not a user of the device has previously reacted to the dimming of the display indicating premature dimming. Still further the dimming delay timer may be influenced by the physical state of the device and the environment in which the device is operating. Each of these methods, used alone or in combination, may provide for an enhanced user experience by reducing the power consumption of a display while improving a user interface by minimizing premature display dimming interruption while a user is viewing information presented on the display.

As described above and as will be appreciated by one skilled in the art, embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (e.g., computer software) embodied in the tangible, non-transitory storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and associated drawings describe example embodiments in the context of certain example combinations of elements and/or functions, it should be appreciated that different combinations of elements and/or functions may be provided by alternative embodiments without departing from the spirit and scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for operation of a display in a first mode;
providing for operation of the display in a second mode; and
transitioning from operating the display in the first mode to operating the display in the second mode in response to an amount of time elapsing without detecting a user input;
wherein the amount of time is variable in response to at least one of:
the information presented on the display in the first mode;
an application presenting the information on the display in the first mode;
a sensor input of a device comprising the display; or
whether or not a user input is detected within a predetermined response time after transitioning from operating the display in the first mode to operating the display in the second mode.

2. The method according to claim 1, wherein the first mode includes a first level of brightness and wherein the second mode includes a second level of brightness that is less than the first level of brightness.

3. The method according to claim 1, wherein the amount of time is variable in response to at least two of:
the information presented on the display in the first mode;
the application presenting the information on the display in the first mode;
a sensor input of the device comprising the display; and
one or more prior occurrences of interruption of the transitioning from operating the display in the first mode to operating the display in the second mode by a user input.

4. The method according to claim 1, wherein the amount of time is variable in response to whether or not a user input is detected within a predetermined response time after transitioning from operating the display in the first mode to operating the display in the second mode, wherein the amount of time is increased in response to detecting a user input within a predetermined response time after transitioning from operating the display in the first mode to operating the display in the second mode, and wherein the increased amount of time is learned and stored for future use.

5. The method according to claim 4, wherein the amount of time is decreased in response to not detecting a user input within a predetermined response time after transitioning from operating the display in the first mode to operating the display in the second mode, and wherein the decreased amount of time is learned and stored for future use.

6. The method according to claim 1, wherein the amount of time is variable in response to the information presented on the display in the first mode, wherein the amount of time is relatively greater in response to the information presented on the display in the first mode being measured at a first difficulty level and relatively lower in response to the information presented on the display in the first mode being measured at a second difficulty level which is lower than the first difficulty level.

7. The method according to claim 1, wherein the amount of time is variable in response to a sensor input of the device comprising the display, wherein the sensor input includes detection of motion of the device.

8. An apparatus comprising at least one processor and at least one memory including computer program code, the at least one memory and the computer program code configured to, with the at least one processor, cause the apparatus to perform:
provide for operation of a display in a first mode;
provide for operation of the display in a second mode; and
transition from operating the display in the first mode to operating the display in the second mode in response to an amount of time elapsing without detecting a user input;
wherein the amount of time is variable in response to at least one of:
the information presented on the display in the first mode;
an application presenting the information on the display in the first mode;
a sensor input of a device comprising the display; or
whether or not a user input is detected within a predetermined response time after transitioning from operating the display in the first mode to operating the display in the second mode.

9. The apparatus according to claim 8, wherein the first mode includes a first level of brightness and wherein the second mode includes a second level of brightness that is less than the first level of brightness.

10. The apparatus according to claim 8, wherein the amount of time is variable in response to at least two of:
the information presented on the display in the first mode;
the application presenting the information on the display in the first mode;
a sensor input of the device comprising the display; and
one or more prior occurrences of interruption of the transitioning from operating the display in the first mode to operating the display in the second mode by a user input.

11. The apparatus according to claim 8, wherein the amount of time is variable in response to whether or not a user input is detected within a predetermined response time after transitioning from operating the display in the first mode to operating the display in the second mode, wherein the amount of time is increased in response to detecting a user input within a predetermined response time after transitioning from operating the display in the first mode to operating the display in the second mode, and wherein the increased amount of time is learned and stored for future use.

12. The apparatus according to claim 11, wherein the amount of time is decreased in response to not detecting a user input within a predetermined response time after transitioning from operating the display in the first mode to operating the display in the second mode, and wherein the decreased amount of time is learned and stored for future use.

13. The apparatus according to claim 8, wherein the amount of time is variable in response to the information presented on the display in the first mode, wherein the amount of time is relatively greater in response to the information presented on the display in the first mode being measured at a first difficulty level and relatively lower in response to the information presented on the display in the first mode being measured at a second difficulty level which is lower than the first difficulty level.

14. The apparatus according to claim 8, wherein the amount of time is variable in response to a sensor input of the device comprising the display, wherein the sensor input includes detection of motion of the device.

15. A computer program product comprising at least one computer-readable storage medium having computer-executable program code instructions stored therein, the computer-executable program code instructions comprising:
program code instructions for providing for operation of a display in a first mode;
program code instructions for providing for operation of the display in a second mode; and
program code instructions for transitioning from operating the display in the first mode to operating the display in the second mode in response to an amount of time elapsing without detecting a user input;
wherein the amount of time is variable in response to at least one of:
the information presented on the display in the first mode;
an application presenting the information on the display in the first mode;
a sensor input of a device comprising the display; or
whether or not a user input is detected within a predetermined response time after transitioning from operating the display in the first mode to operating the display in the second mode.

16. The computer program product according to claim 15, wherein the first mode includes a first level of brightness and wherein the second mode includes a second level of brightness that is less than the first level of brightness.

17. The computer program product according to claim 15, wherein the amount of time is variable in response to at least two of:
the information presented on the display in the first mode;
the application presenting the information on the display in the first mode;
a sensor input of the device comprising the display; and
one or more prior occurrences of interruption of the transitioning from operating the display in the first mode to operating the display in the second mode by a user input.

18. The computer program product according to claim 15, wherein the amount of time is variable in response to whether or not a user input is detected within a predetermined response time after transitioning from operating the display in the first mode to operating the display in the second mode, wherein the amount of time is increased in response to detecting a user input within a predetermined response time after transitioning from operating the display in the first mode to operating the display in the second mode, and wherein the increased amount of time is learned and stored for future use.

19. The computer program product according to claim 18, wherein the amount of time is decreased in response to not detecting a user input within a predetermined response time after transitioning from operating the display in the first mode to operating the display in the second mode, and wherein the decreased amount of time is learned and stored for future use.

20. The computer program product according to claim 15, wherein the amount of time is variable in response to the information presented on the display in the first mode, wherein the amount of time is relatively greater in response to the information presented on the display in the first mode being measured at a first difficulty level and relatively lower in response to the information presented on the display in the first mode being measured at a second difficulty level which is lower than the first difficulty level.
